(19) United States
(12) Patent Application Publication
(10) Pub. No.: US 2016/0218550 A1
(43) Pub. Date: Jul. 28, 2016

(54) PORTABLE CHARGING STATION AND METHOD FOR CHARGING PORTABLE ELECTRONIC DEVICES

(71) Applicant: Graham T. MacWilliams, Los Altos Hills, CA (US)

(72) Inventor: Graham T. MacWilliams, Los Altos Hills, CA (US)

(21) Appl. No.: 14/606,028

(22) Filed: Jan. 27, 2015

(51) Int. Cl. H02J 7/35

(52) U.S. Cl. CPC H02J 7/35

(57) ABSTRACT

The present invention is directed to an apparatus and a method for charging a portable electrical device that features a switching system to selectively place an electrical storage subsystem in electrical communication with a source of light and a photovoltaic transducer. In one embodiment, the source of light is configured to direct optical energy upon a mounting surface and the photovoltaic transducer include optical sensors disposed on a sensing surface of the apparatus disposed opposite to the mounting surface. In another embodiment the optical sensors are disposed in the mounting surface. An electrical storage subsystem is included in the apparatus that is selectively placed in electrical communication with one of the photovoltaic transducer and the source of light. The source of light may be a single source of light or a plurality of light emitters.

The present invention relates to electricity production and more particularly to the charging of electronic devices not continuously coupled to an electrical grid.

Historically, electricity is generated at a central location, commonly referred to as a power station, and transmitted over a network of transmission lines to substations located proximate to demand centers. This is referred to as an electrical grid. The substations typically step-down the voltage and transmit the stepped-down electricity to end users of the demand centers. With the advent of computing technology mobile devices using electricity have increased the demand for devices that use electricity and are not continuously coupled to the electrical grid. Examples of such devices include cameras, sensors, telephones, radios, tablet computers, wearable electronic devices, lighting systems, automobiles and drones just to name a few.

Mobile electrical devices, such as cellular telephones, computing tablets and laptops have become the preferred device for the personal computing experience and have driven recent changes in power generating technology. This is, in part, attributable to the ease of transport that provides substantially continued access, as well as the expansion of wireless access to networked computing environments, such as the internet. Additionally, the computational power of these devices has attained a level almost equal to that of the traditional desktop computing environment. However, with the increased computational power of the mobile electrical devices the energy usage of the same also increases. This provides the deleterious effect of necessitating an increase in the size of the power storage device, e.g., battery. This reduces one or more of the attractive features of these devices, ease of transport. As the size of the power storage device increases, so does the size and weight of the mobile electrical device. The typical solution to overcome the conflicting requirements of increasing the computation power of a mobile electrical device without increasing the weight and/or size of the same is to increase the efficiency of the computing device and/or the efficiency of the energy storage system. Another manner by which to address these conflicting requirements is to reduce the time required to charge a mobile device or increase the ease of charging the device.

One manner in which to increase the ease of charging a mobile device employs magnetic resonance charging, also known as electromagnetic induction charging. To that end, the mobile electronic device is fitted with a shroud, or “sleeve”, that facilitates coupling of electrical charge generated from a base station hardwired to the electrical grid. The shroud includes connectors compatible with the electrical charging receptacles of the mobile electronic device. The base inductively couples electrical energy from the grid to the shroud, which in turn, transmits electrical energy to the mobile electronic device. Specifically, the base emits an oscillating magnetic field that induces electric current in the “sleeve”. Electrical current is transmitted to the mobile electronic device's battery using the conventional charge port included with the mobile electronic device mobile device.

U.S. Pat. No. 6,906,495 to Cheng et al. discloses a system and method for transferring power that does not require direct electrical conductive contacts. There is provided a primary unit having a power supply and a substantially laminar surface having at least one conductor that generates an electromagnetic field when a current flows therethrough and having an active area defined within a perimeter of the surface, the at least one conductor being arranged such that electromagnetic field lines generated by the at least one conductor are substantially parallel to the plane of the surface within the active area; and at least one secondary device including at least one conductor that may be wound about a core; wherein the active area has a perimeter large enough to surround the conductor or core of the at least one secondary device in any orientation thereof substantially parallel to the surface of the primary unit in the active area, such that when the at least one secondary device is placed on or in proximity to the active area in a predetermined orientation, the electromagnetic field induces a current in the at least one conductor of the at least one secondary device.

U.S. Pat. No. 7,271,569 to Oglesbee discloses a contactless, inductive charger having a generally planar surface is provided. An image, text or other visual indicator is disposed upon the substantially planar surface such that the visual indicator represents a preferred placement orientation for an electronic device for optimal inductive charging. The charger includes a primary coil positioned within the boundaries of the image, such that a user has a visual guide for placing the device on the charging surface for maximum efficiency in charging. The visual indicator, which may be a picture, outline, text or other directional indicator, may be geometrically similar to a shape of the electronic device or may be in the shape of a generic device. It may be disposed upon the charger by a method selected from the group consisting of painting, molding, silk screening, plating, vapor deposition and adhesive retention. Drawbacks with the prior art charging systems are manifold, including incompatibility of conflicting charging standards and perceived health issues with the presence of inductively coupled electromagnetic energy into a surrounding ambient.

A need exists, therefore, to provide improved techniques for charging of portable electronic devices.

### BRIEF SUMMARY OF THE INVENTION

The present invention is directed to an apparatus and a method for charging a portable electrical device that features a switching system to selectively place an electrical storage subsystem in electrical communication with a source of light and a photovoltaic transducer. In one embodiment, the source of light is configured to direct optical energy upon a mounting surface and the photovoltaic transducer include optical sensors disposed on a sensing surface of the apparatus located opposite to the mounting surface. In another embodiment the optical sensors are disposed in the mounting surface. An electrical storage subsystem is included in the apparatus that is selectively placed in electrical communication with one of the photovoltaic transducer and the source of light. The source of light may be a single source of light or a plurality of light emitters. In one embodiment the source of light includes a plurality of light emitting diodes arranged to direct optical energy toward the mounting surface. Also disclosed is a method to operate the charging station. These and other embodiments are described more fully below.

### BRIEF DESCRIPTION OF THE DRAWINGS

FIG. 1 is a simplified side view of a charging station in accordance with a first embodiment of the present invention;

FIG. 2 is a simplified top view of an example of an electrical device that may employ the present invention;

FIG. 3 is a simplified side view of a charging station in accordance with a second embodiment of the present invention;

FIG. 4 is a simplified side view of a charging station in accordance with a third embodiment of the present invention;

FIG. 5 is a top down view of the charging station shown in FIG. 4;

FIG. 6 is a detailed view of an emitter-sensor pair shown in FIG. 7 in accordance with an alternate embodiment of the present invention.

FIG. 7 is a flow diagram demonstrating the operation of the charging station shown in FIGS. 4 and 5; and

FIG. 8 is a flow diagram demonstrating the operation of the charging station shown in FIGS. 4 and 5 in accordance with an alternate embodiment.

### DETAILED DESCRIPTION OF THE INVENTION

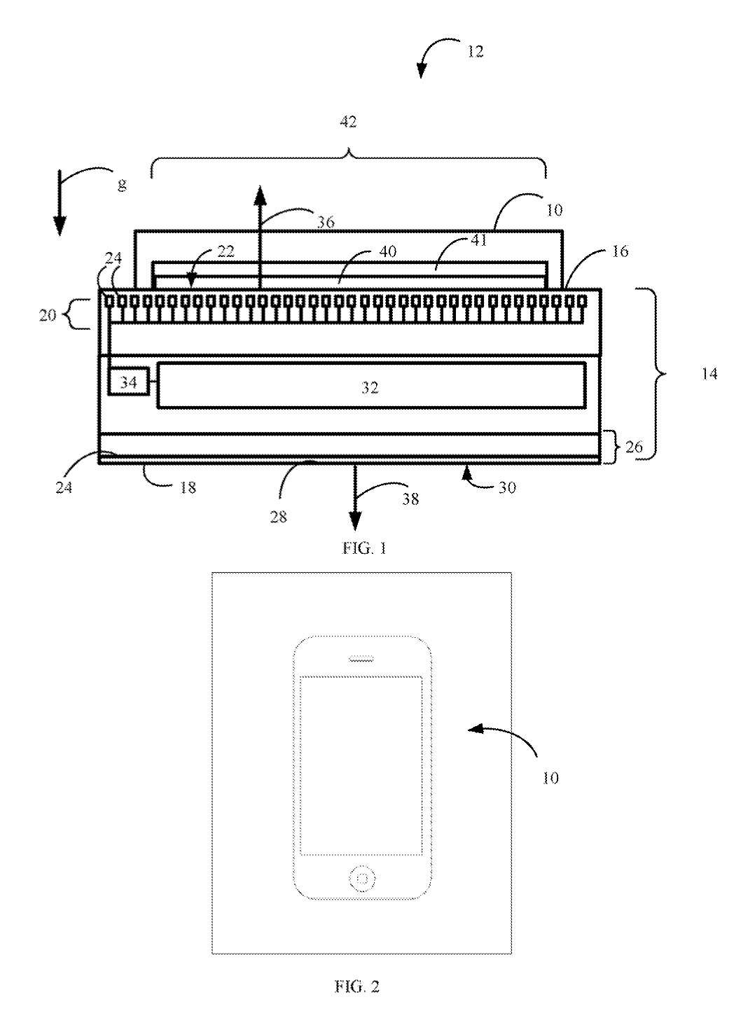

Referring to FIG. 1 one example of the present invention for use in charging an electrical device 10 includes a charging station 12. Charging station 12 includes a body 14 having opposed sides 16 and 18. A source of light 20 is included within body 14 to impinge optical energy upon side 16. In this manner, optical energy produced by source 20 travels toward a mounting surface 22 and impinges upon objects resting on mounting surface 22, such as electrical device 10. Thus, side 16 of body 14 is fabricated from a material that allows optical energy from source 20 to propagate therethrough. Although any type of light source may be employed, such as a single incandescent light (not shown) or fluorescent light (not shown). In the present example, however, source 20 consists of a plurality of point light sources 24. Any type of point light sources may be employed, such as light emitting diodes, laser diodes and the like.

Disposed proximate to side 18 is a photovoltaic transducer system 26. Photovoltaic transducer system 26 includes light sensors, such as solar cells 28 that face a surface 30 of side 18. Side 18 is formed from a material that is substantially transparent to optical energy impinging upon surface 30. In this manner, optical energy, such as sunlight, impinging upon surface 30 is sensed by solar cells 28 whereby photovoltaic transducer system 26 converts into electrical energy, e.g., direct current electrical energy. Any suitable electrical storage subsystem 32 capable of storing the electrical energy produced by photovoltaic transducer system 26 such as a battery, is included in body 14. To facilitate electrical communication between photovoltaic transducer system 24 and electrical storage subsystem 32, a switching circuit 34 is included.

Switching circuit 34 is configured to selectively place one of source 20 and photovoltaic transducer system 26 in electrical communication with electrical storage subsystem 32. In this manner, electrical communication between photovoltaic transducer system 26 electrical storage subsystem 32 may be prevented while electrical communication between electrical storage subsystem 32 and source 20 is facilitated. Conversely, switching circuit 34 also operates to facilitate electrical communication between photovoltaic transducer system 26 and electrical storage subsystem 32 while preventing electrical communication between electrical storage subsystem 32 and source 20.

One embodiment of a switching system 34 that would meet these requirements would include a gravity-sense switch. The gravity sense switch would determine if the solar cells 28 on side 18 or the source of light 20 on side 16 was facing upwards. The side facing upwards would be connected to storage system 32. Another embodiment of a switching system 34 that would meet these requirements would include a pressure-sense switch mounted on either or both sides 18 and 16. For example, if a single pressure-sense switch was mounted on side 16, and it sensed contact with a surface (that is, surface 16 faced downwards), then switching system 34 would connect the solar cells 28 on side 18 to the storage system. If the single pressure-sense switch mounted on side 16 did not sense contact with a surface (that is, surface 16 faced upwards), then switching system 34 would connect the source of light 20 on side 16 to the storage system 32 to provide the required power. A similar logic could be employed if pressure-sense switches were mounted on both sides 16 and 18 to offer a more robust indication of which surface was facing downward (in contact). Another embodiment of switching system 34 would include an assessment of the area of the device to be charged. For example, a larger device, like a large smartphone or tablet, would be expected to require more charge, while a smaller device, such as a watch device, would require less total charge. In the absence of a communication system between device 10 and charge station, this area-sense capability would act as an approximation for the total required charge.

In one embodiment, operation of charging station 12 includes switching circuit 34 operating in response to gravity g̅. The electrical communication between electrical storage subsystem 32 and either source 20 and photovoltaic transducer system 26 is related to the orientation of gravity g̅ with respect to normal 36 of surface 22 and normal 38 of surface 30. For example, as shown in FIG. 1, normal 36 is oriented in a direction opposite to gravity g̅ and normal 38 is orientated to extend in the same direction as gravity g̅. This results in switching circuit 34 placing source 20 in electrical communication with electrical storage subsystem 32. As a result, source 20 is powered by electrical storage subsystem 34 generates optical energy that propagates through side 16, away from surface 22 and impinges upon device 10 resting thereupon. Concurrently, electrical storage subsystem 32 is isolated from photovoltaic transducer system 26. One advantage of concurrently isolating electrical storage subsystem 32 from photovoltaic transducer system 26 while source 20 is being powered is to maximize the amount of energy available to source 20 by avoiding the presence of a parasitic load. This reduces the time required to charge device 10. It is conceivable that virtually any design of rechargeable battery may be employed, such as a lithium-ion battery, nickel cadmium battery, nickel metal hydride battery, nickel polymer battery, lithium sulfur battery, potassium-ion battery and the like.

Should charging station 12 be positioned so that normal 38 is oriented in a direction opposite to gravity g̅ and normal 36 is orientated to extend in the same direction as gravity g̅, switching circuit 34 would electrically isolate source 20 from electrical storage subsystem 32 while concurrently placing photovoltaic transducer system 26 in electrical communication therewith. This minimizes the time required to fully charge electrical storage subsystem 32 by avoiding placing a load on the same with source 20. With this configuration the ease with which charging station 12 may be used is demonstrated by understanding that by merely resting charging station 12 on side 18, e.g., surface 30 resting upon and facing a surface, such as a table top (not shown) source 20 is activated. By lying charging station 12 on side 16, e.g., resting surface 22 against a surface, such as a table top (not shown), photovoltaic transducer system 26 operates to charge electrical storage subsystem 32. It is desired that when charging station 12 rests on side 16 that charging station 12 is in an area where side 18 is exposed to optical energy with a sufficient flux and appropriate wavelength to cause photovoltaic transducer system 26 to generate current and charge electrical storage subsystem 32.

Referring to both FIGS. 1 and 2, an example of electrical device 10 that may employ the current invention is shown, which is commonly referred to as a smart phone. One such smart phone is sold by Apple Computer of Cupertino, Calif. under the trade name iPhone®, or the mobile electrical device available from the Open Handset Alliance of South Korea under the name Android®. To take advantage of the features of charging station 12, electrical device 10 includes a photovoltaic electrical power generator 40 to sense desired frequencies of light and generate electrical current in response thereto. A primary power storage system 41 is included to store the electrical current generated by electrical power generator 40.

It is conceivable that operation of charging station 12 may occur in a myriad of situations. For example, charging may occur in locations where optical energy generated by source 20 diffusing into the environment surrounding charging system 12 is undesired. One manner in which to ameliorate this issue is by concurrently charging multiple electrical devices 10 at a given time. To that end, mounting surface may be configured to have a surface area to allow multiple electrical devices 10 to be resting thereupon at any given time. It should be understood that the multiple electrical devices 10, need to be the same. Rather, different types of electrical devices may be concurrently charged at a given time by concurrently resting upon mounting surface 22, e.g., an iPad, and iPhone and the like.

Another manner in which to satisfy this requirement is to control the flux of optical energy produced by source 20 so as to illuminate only regions 42, of surface 22 that is in superimposition with one or more electrical devices 10 resting thereupon. This could be achieved, in part, by minimizing the optical energy impinging upon surface 22 outside of region 22. However, it is desirous to maximize the flux of optical energy impinging upon electrical device 10, i.e., to minimize the portions of electrical device 10 that sense optical energy in furtherance of producing electrical current in response thereto that are outside of the flux of the optical energy. To that end, alignment marks (not shown) may be present on surface to indicate the proper orientation of electrical device 10 with respect to source 20. The marks (not shown) may be indicia (not shown) present on surface 29 may be detents (not shown) or protrusions (not shown) extending therefrom and between the sides of electrical device 10.

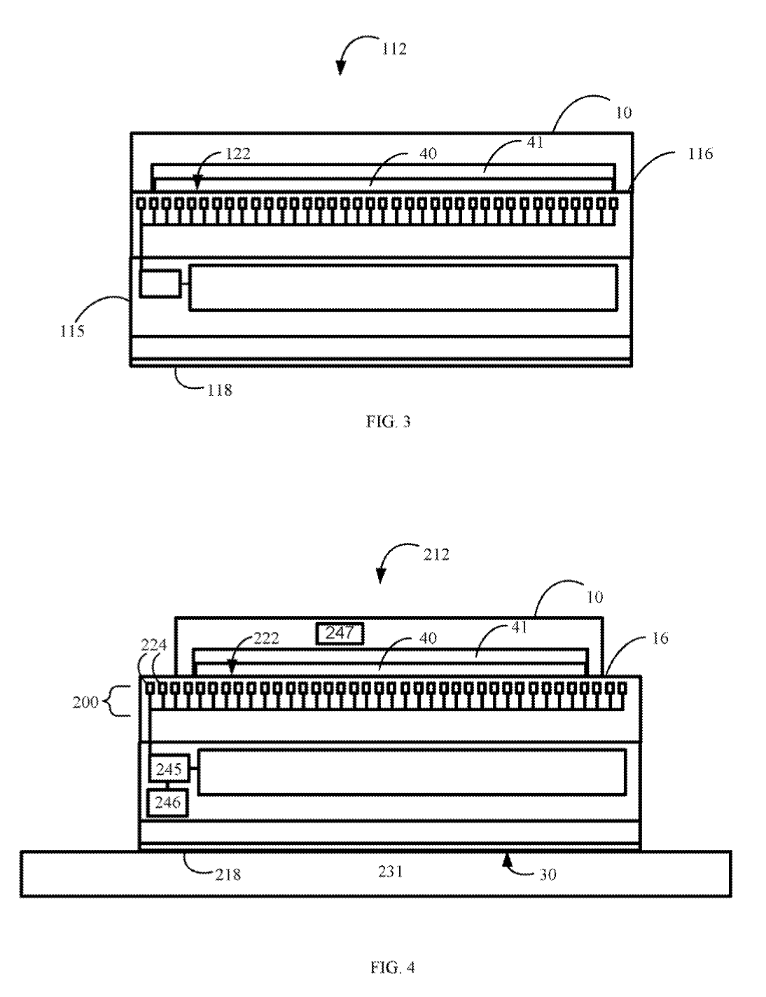

Referring to both FIGS. 1 and 3 another embodiment of charging system 12 is shown as charging system 112 and is identical to charging system 12, except that surface 22 of charging system 112 is coextensive with a single electrical device 10. As a result, more precise control over optical energy diffusing into the environment surrounding charging system 112 is afforded. In this manner, the entire area of surface 122 is in superimposition with electrical device 10. The ease of alignment between side 116 and electrical device 10 may be achieved by using a user's fingers (not shown). Alternatively, guides may be present on a periphery 115 of body 118 between which are fitted the sides of electrical device 10.

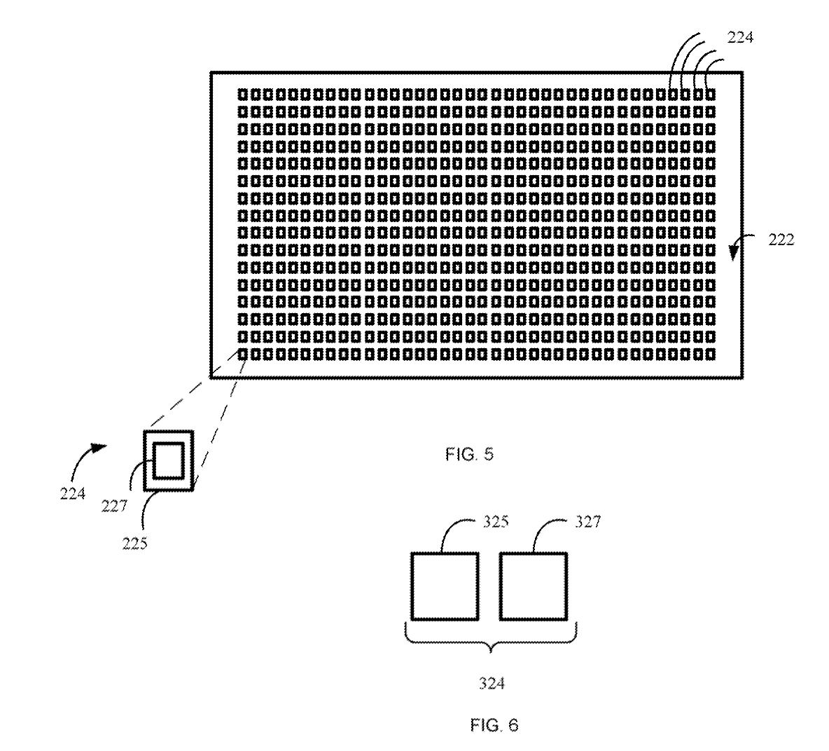

Referring to FIGS. 4 and 5, another embodiment of charging station 212 relaxes the alignment requirements of source 200 with electrical device 10 while minimizing the diffusion of light into environment surrounding charging station 212. To that end, source 200 consists of a plurality of spaced-apart emitter-sensor pairs 224. Each of which is in electrical communication with processor 245. Each emitter-sensor pair 224 includes an emitter of optical energy 225 and an optical sensor 227. Thus provided are a plurality of spaced-apart light emitters 225, and a plurality of spaced-apart optical sensors 227. Each of spaced-apart emitters 225 is proximate to one of the plurality of spaced-apart optical sensors 227. As shown, each emitter 225 is concentric with one of the plurality of spaced-apart optical sensors 227. The plurality of spaced-apart emitter-sensor pairs 224 is arranged to emit light from a common plane in grid or matrix. However, it should be understood that any arrangement may be provided. It is desired, however, that the arrangement of the plurality of emitter-sensor pairs 227 be periodic. Optical sensors 227 control light emitters 225 so that only light emitters 225 in superimposition with electrical device 10 function. The remaining light emitters 225 do not emit optical energy. Optical sensors 227 of the emitter-sensor pairs 224 operate to produce signals that allow processor 245 to sense the shape of electrical device 10 and produce an illuminated region corresponding to the shape. As with charging station 12 of FIG. 1, charging station 212 of FIG. 4 may be configured to allow concurrently charging of multiple charging devices 10. To that end, mounting surface 222 has a surface area to accommodate resting multiple electrical devices 10 thereon, concurrently.

The operation of optical sensors 227 of the plurality of emitter-sensor pairs 225 depends upon the level of ambient light of the environment in which charging station 212 is present. It should be understood that emitters 225 and sensors 227 need not be concentrically disposed. Emitters 325 and sensors 327 of emitter-sensor pairs 324 may be positioned side-by-side, as show in FIG. 6. Referring to both FIGS. 5 and 6, sensors 227 and 327 may be any one of variety of sensors available from companies such as Vishay Intertechnology, Inc. located at 63 Lancaster Avenue Malvem, Pa. 19355-2143; Intersil Corporation located at 1001 Murphy Ranch Road, Milpitas, Calif. 95035; and Digi-Key Corporation located at 701 Brooks Avenue South, Thief River Falls, Minn. 56701.

Referring to FIGS. 4, 5 and 7, assume that charging station 212 is in an environment in which the level of ambient light was sufficient to create an optical flux differentiation between different sets of optical sensors 227. Specifically, at step 400, one side 218 of charging station is placed facing a surface, e.g., table 231. At step 402, one or more electrical device 10 is placed upon surface 222. As a result, optical sensors 227 of a first set of emitter-sensor pairs 224 are covered. At step 404 sensors 227 sense optical energy. In this arrangement a substantial reduction of optical flux is sensed by sensors 227 in superimposition with electrical device 10. Specifically, at step 406 processor 245 determines whether a first set of sensors 227, those that are not in superimposition with electrical device 10, sense a greater amount of optical flux than a second set of optical sensors 10, those in superimposition with electrical device 10. If that is the case, then step 408 occurs during processor 245 activates emitters 225 associated with the second set. The result is that only emitters 225 in superimposition with one or more electrical devices 10 are activated. This reduces, if not prevents, the amount of energy required to charge electrical device by not illuminating unnecessary emitters 225. It also provides the additional benefit of reducing optical energy diffusing away from charging station 212 and into the surrounding environment. Following activation of emitters at step 408, step 410 occurs during which processor 245 determines whether a desired charge in primary power storage system 41.

If it is determined at step 410 that a desired charge was present, the step 412 occurs. At step 412, emitters 225 are terminated and the process ends at step 414 Should it be determined at step 408 that charging station 212 be present in environment in which the level of ambient light was insufficient to create an optical flux differentiation between different sets of optical sensors 227, step 416 would occur. At step 416, processor 245 activates all emitters 225. The level of activation, however, may be any desired so long as a flux differential between two sets of sensors 227 may be detected in response to the activation of emitters, which would be identified at step 418. For example, assume that emitters are activated at full flux emission. Sensors 227 of the first set, those that are not in superimposition with one or more electrical devices 10, would sense a lower amount of optical flux than a second set of optical sensors 227, those in superimposition with electrical device 10. This results from the reflection of optical energy from one or more electrical devices 10. As a result, processor 245 deactivates emitters 225 associated with the first set of sensors at step 420. The result is that only emitters 225 in superimposition with one or more electrical devices 10 are active. This reduces, if not prevents, optical energy diffusing away from charging station 212 and into the surrounding environment. Following step 420, steps 410, 412 and 414 would occur, as discussed above.

Referring to FIGS. 4, 5 and 8, it should be understood, however, that the emitters 225 need not operate at full illumination. Rather, a lower level of illumination may be employed until the first set of emitters is deactivated. Following deactivation of emitters 225 of the first set by processor 245, processor 245 operates emitters 225 of the second set at the desired level, which in the case to minimize charge time could be a maximum level of optical energy emission. This is demonstrated by inclusion step 518 following step 516 with an understanding that steps 500, 502, 504, 506, 508, 510, 512, 514 and 516 are that same as steps 400, 402, 404, 406, 408, 410, 412, 414 and 416, respectively. Specifically, at step 518 processor 245 determines whether there is a differential in optical energy sensed between different groups of sensors 227. If not, step 520 occurs, during which processor 245 increases the optical energy produced by emitters 225. Following step 520, step 518 occurs again, with the understanding that this loop continues until differential is sensed. Once the differential in optical energy sensed between different groups of sensors 227 is sensed at step 518, step 522 occurs. At step 522 emitters 225 associated with sensors sensing the least amount of optical energy are deactivated. Thereafter, steps 510, 512 and 514 occur.

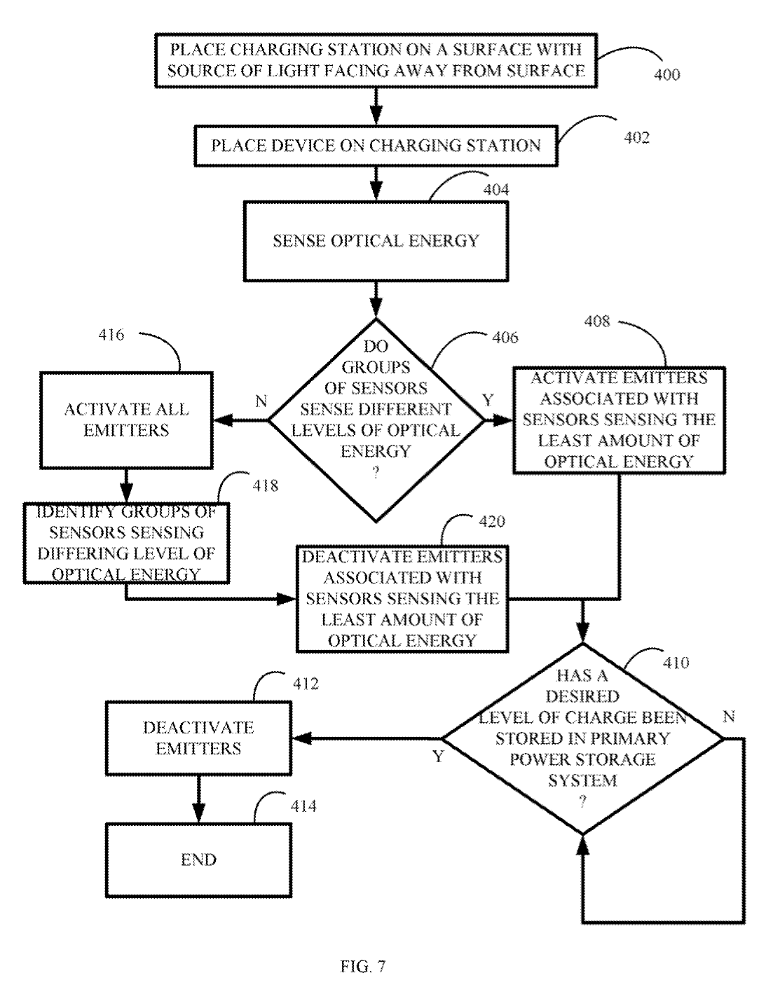

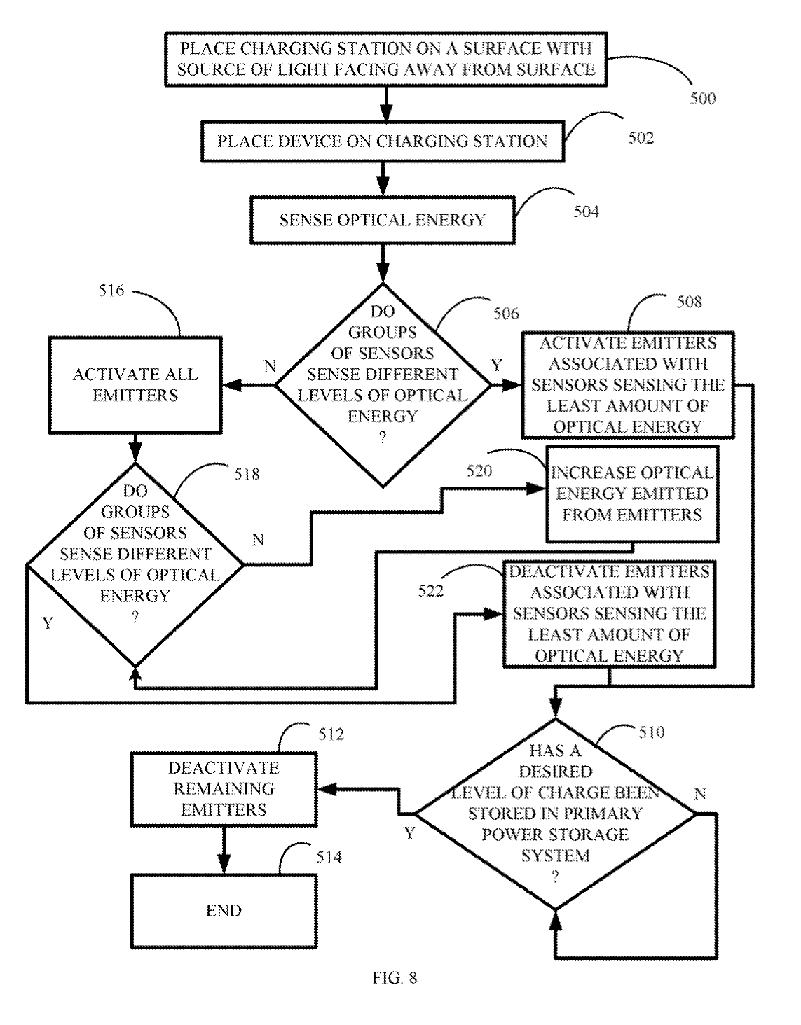

Referring to both FIGS. 7 and 8 the manner for determining whether one or more electrical devices 10 has desired level of charge stored in primary power storage system 41 is manifold. Firstly, communication between one or more electrical devices 10 and each of charging stations 12, 112 and 212 may be effectuated by any known communication system, e.g., blue tooth, near field, infra-red and the like. For the sake of brevity, the communication between one or more electrical devices 10 and charging stations 12, 112 and 212 will be discussed with respect to charging station 212, with the understanding that the discussion applies equally with respect to charging stations 12, and 112.

Referring to FIGS. 4, 7 and 8, operation of charging station is under control of processor 245 and includes wireless transceiver 246, such as a transmitter that facilitates exchanging data over short distances using short-wavelength ultra-high radio waves, e.g., from 2.4 to 2.485 GHz, common called a Bluetooth transceiver. A subset of one or more electrical devices 10 also includes a wireless transceiver 247 that is compatible for communicating with transceiver 246. Upon charging of primary power storage system 41 processor 245 interacts with electrical device 10 to monitor the charge therein through wireless communication between transceivers 246 and 247. To that end, transceiver 246 is in data communication with processor 245. The amount of charge held in primary power storage system 41 may be communicated to processor vis-à-vis a program (not shown) included in electrical device 10. For example, were one or more electrical devices 10 an iPhone® then an application (not shown) on electrical device may be included that facilitates monitoring of electrical characteristics of primary power storage system 241. Examples of characteristics of primary power storage system 241 that may be monitored include the charge capacity, the charge rate and the like. As a result, were it determined that the rate of charge of device had slowed, e.g., as the primary power storage system 241 reaches a predetermine threshold level, e.g. 90% of capacity, then the illumination of emitters may be adjusted, in this case, reduced, to conserve energy in electrical storage subsystem 32. In this manner, charging station 212 may optimally charge the system with high optical fluence (electrical current) early in the charge cycle while the battery was low, and to reduce the rate of charge and be readily available to charge additional electrical devices (not shown) if required.

It should be understood that the foregoing description is merely an example of the invention and that modifications may be made thereto without departing from the spirit and scope of the invention and should not be construed as limiting the scope of the invention. For example, a jump case may be employed as discussed more fully in U.S. patent application Ser. No. 13/920,013 filed Jun. 17, 2013 and entitled TECHNIQUES AND SYSTEMS FOR GENERATING POWER USING MULTI-SPECTRUM ENERGY and having Graham T. MacWilliams and Duncan S. MacWilliams listed as inventors and is incorporated by reference herein. Additionally, the foregoing discussion is with respect to mobile electrical devices; however, the present invention may be employed with electrical devices that are not mobile, i.e., continuously and/or intermittently connected to an electrical grid. Furthermore, discussing the implementation of the present invention in a smartphone is not meant to limit the application of the current invention to smartphone mobile electrical devices. The present invention may be implemented in virtually any mobile electrical device, such as cameras, sensors, telephones, radios, tablet computers, wearable electronic devices, lighting systems, automobiles and drones just to name a few. The scope of the invention should be determined with respect to the appended claims, including the full scope of equivalents thereof.

1. An apparatus for charging an electrical device, said system comprising:
a surface;
a source of light to direct optical energy toward said surface;
a photovoltaic transducer,
an electrical storage subsystem; and
a switching system to selectively place said electrical storage subsystem in electrical communication with said source of light and said photovoltaic transducer.

2. The apparatus as recited in claim 1 wherein said switching system selectively places one of said source of light and said photovoltaic subsystem in electrical communication with said electrical storage subsystem while electrically isolating the remaining of said source of light and said photovoltaic subsystem from the electrical storage subsystem.

3. The apparatus as recited in claim 1 where said switching system selectively places said source of light in electrical communication with said electrical storage subsystem in response to sensing said surface being orientated a predetermined manner with respect to gravity.

4. The apparatus as recited in claim 1 where said source of light includes a plurality of light emitting diodes.

5. The apparatus as recited in claim 1 wherein said apparatus has a body with opposing sides, with one of said opposing sides including said surface and the remaining opposing side having said photovoltaic transducer disposed to sense light impinging thereupon.

6. The apparatus as recited in claim 1 further including a processor in data communication with a computer readable memory having computer readable instructions stored therein when operated on by said processor causes said apparatus to carry out the steps sensing optical energy over an area of the surface upon which said electrical device is placed; identifying regions of said surface having different flux of optical energy impinging thereupon, defining a shape; and activating said source of light to direct optical energy toward said surface to illuminate said shape.

7. The apparatus as recited in claim 6 wherein said computer readable instructions operated on by said processor carry out the step of activating further includes computer code to cause said source to direct optical energy toward said surface while avoiding illuminating regions of said surface outside of said shape.

8. The apparatus as recited in claim 6 wherein said computer readable instructions operated on by said processor carry out the step of sensing includes computer code to cause said charging system to carry out the step of sensing after activating.

9. The apparatus as recited in claim 6 wherein said computer readable instructions operated on by said processor carry out the step of sensing includes computer code to cause said charging system to carry out the step of sensing before activating.

10. An apparatus for charging an electrical device, said system comprising:
a body having opposing sides, with one of said opposing sides defining a mounting surface and the remaining opposing defining a sensing surface;
a plurality of light emitting diodes each of which is to direct optical in a direction normal to said mounting surface;
a photovoltaic transducer disposed to sense light energy impinging upon said sensing surface;
an electrical storage subsystem; and
a switching system to selectively place said electrical storage subsystem in electrical communication with said source of light and said photovoltaic transducer.

11. The apparatus as recited in claim 10 wherein said switching system selectively places one of said source of light and said photovoltaic subsystem in electrical communication with said electrical storage subsystem while electrically isolating the remaining of said source of light and said photovoltaic subsystem from the electrical storage subsystem.

12. The apparatus as recited in claim 11 where said switching system selectively places said source of light in electrical communication with said electrical storage subsystem in response to sensing said surface being orientated a predetermined manner with respect to gravity.

13. The apparatus as recited in claim 12 further including a processor in data communication with a computer readable memory having computer readable instructions stored therein when operated on by said processor causes said apparatus to carry out the steps:
sensing optical energy over an area of the surface upon which said electrical device is placed;
identifying regions of said surface having different flux of optical energy impinging thereupon, defining a shape; and
activating said source of light to direct optical energy toward said surface to illuminate said shape,
sensing optical energy over an area of a surface upon which said electrical device is placed;
identifying regions of said surface having different flux of optical energy impinging thereupon, defining a shape; and
activating a source of light to direct optical energy toward said surface to illuminate said shape.

14. The apparatus as recited in claim 6 wherein said computer readable instructions operated on by said processor carry out the step of activating further includes computer code to cause said source to direct optical energy toward said surface while avoiding illuminating regions of said surface outside of said shape.

15. A method of operating a charging station for a portable electronic device, said method comprising:
providing said charging station with a body having opposing sides, with one of said opposing sides defining a mounting surface and the remaining opposing side defining a sensing surface, a source of light, a photovoltaic transducer and an electrical storage subsystem and a switching system, the method comprising:
alternatingly placing both said source of light and said photovoltaic subsystem in electrical communication with said an electrical storage subsystem.

16. The method as recited in claim 15 where alternatingly placing further includes selectively placing said source of light in electrical communication with said electrical storage subsystem in response to sensing said surface being orientated a predetermined manner with respect to gravity.

17. The method as recited in claim 15 where selectively placing further includes placing said source of light in electrical communication with said electrical storage subsystem and electrically isolating said electrical storage subsystem from said photovoltaic transducer in response to sensing said surface being orientated a predetermined manner with respect to gravity.

18. The method as recited in claim 15 where selectively placing further includes concurrently placing said source of light in electrical communication with said electrical storage subsystem while electrically isolating said electrical storage subsystem from said photovoltaic transducer in response to sensing said surface being orientated a predetermined manner with respect to gravity.

19. The method as recited in claim 15 further including sensing optical energy over an area of the surface upon which said electrical device is placed, identifying regions of said surface having different flux of optical energy impinging thereupon, defining a shape; and activating said source of light to direct optical energy toward said surface to illuminate said shape.

20. The method as recited in claim 19 wherein activating further includes having said source direct optical energy toward said surface to avoid illuminating regions of said surface outside of said shape.
